(19) United States
(12) Patent Application Publication
(10) Pub. No.: US 2024/0064799 A1
(43) Pub. Date: Feb. 22, 2024

(54) SIDELINK CONTROL SIGNALING USING UNLICENSED SPECTRUM

(71) Applicant: QUALCOMM Incorporated, San Diego, CA (US)

(72) Inventors: Yisheng Xue, San Diego, CA (US); Jing Sun, San Diego, CA (US); Chih-Hao Liu, San Diego, CA (US); Xiaoxia Zhang, San Diego, CA (US); Giovanni Chisci, San Diego, CA (US)

(21) Appl. No.: 17/889,344

(22) Filed: Aug. 16, 2022

(51) Int. Cl. H04W 74/08; H04W 16/14; H04W 72/04; H04W 56/00

(52) U.S. Cl. CPC H04W 74/0808; H04W 16/14; H04W 72/0406; H04W 56/001

(57) ABSTRACT

This disclosure provides systems, methods and apparatus, including computer programs encoded on computer storage media, for sidelink control signaling using unlicensed spectrum. Wireless devices may perform a listen-before-talk (LBT) procedure before accessing a channel of the unlicensed spectrum, and may be unable to access the unlicensed spectrum in some circumstances. In some implementations, a wireless device may leverage resources available for transmitting a sidelink synchronization signal block (S-SSB) for additionally transmitting control signaling. For example, a wireless device may multiplex (such as frequency domain multiplexing) a control signal with a S-SSB, which may be transmitted in accordance with a relaxed LBT threshold. In some implementations, the control signal may include information such as an indication of LBT failure or an LBT status, or may be used to detect a radio link failure (RLF), or may be used the short control signal to synchronize sidelink clusters, among other examples.

### TECHNICAL FIELD

This disclosure relates to wireless communications, including sidelink control signaling using unlicensed spectrum.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for a wireless communications at a user equipment (UE). The method may include transmitting a sidelink synchronization signal block (SSB) using a first resource of a channel of an unlicensed radio frequency spectrum band and transmitting control signaling using a second resource of the channel of the unlicensed radio frequency spectrum band, where the control signaling is frequency-division multiplexed with the SSB.

Another innovative aspect of the subject matter described in this disclosure can be implemented in an apparatus for wireless communications at a UE. The apparatus may include one or more interfaces configured to output a sidelink SSB using a first resource of a channel of an unlicensed radio frequency spectrum band and output control signaling using a second resource of the channel of the unlicensed radio frequency spectrum band, where the control signaling is frequency-division multiplexed with the SSB.

Another innovative aspect of the subject matter described in this disclosure can be implemented in another apparatus for wireless communications at a UE. The apparatus may include means for transmitting a sidelink SSB using a first resource of a channel of an unlicensed radio frequency spectrum band and means for transmitting control signaling using a second resource of the channel of the unlicensed radio frequency spectrum band, where the control signaling is frequency-division multiplexed with the SSB.

Another innovative aspect of the subject matter described in this disclosure can be implemented in a non-transitory computer-readable medium storing code for wireless communications at a UE. The code may include instructions executable by a processor to transmit a sidelink SSB using a first resource of a channel of an unlicensed radio frequency spectrum band and transmit control signaling using a second resource of the channel of the unlicensed radio frequency spectrum band, where the control signaling is frequency-division multiplexed with the SSB.

Some implementations of the method, apparatuses, and non-transitory computer-readable medium described herein may include operations, features, means, or instructions for receiving an indication of an allocation of resources of the unlicensed radio frequency spectrum band, and transmitting the control signaling using the second resource in accordance with the allocation of resources. In some implementations, transmitting the control signaling may be in accordance with a transmission time interval (TTI) associated with the allocation of resources.

Some implementations of the method, apparatuses, and non-transitory computer-readable medium described herein may include operations, features, means, or instructions for selecting the second resource of the channel according to a device identifier, on an index of a TTI associated with transmitting the control signaling, or a combination thereof.

In some implementations of the method, apparatuses, and non-transitory computer-readable medium described herein, the control signaling may include an indication of a listen-before-talk (LBT) failure, an indication of a quantity of LBT attempts, or a combination thereof.

In some implementations of the method, apparatuses, and non-transitory computer-readable medium described herein, transmitting the control signaling frequency-division multiplexed with the SSB is associated with an LBT exemption.

Some implementations of the method, apparatuses, and non-transitory computer-readable medium described herein may further include operations, features, means, or instructions for detecting a radio link failure (RLF) with another sidelink device, and transmitting the control signaling may be associated with the RLF.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example of a wireless communications system that supports sidelink control signaling using unlicensed spectrum.

FIG. 2 shows an example of a signaling diagram that supports sidelink control signaling using unlicensed spectrum.

FIGS. 3 and 4 show examples of resource configurations that support sidelink control signaling using unlicensed spectrum.

FIGS. 5 and 6 show examples of process flows that support sidelink control signaling using unlicensed spectrum.

FIGS. 7 and 8 show examples of signaling diagrams and resource configurations that support sidelink control signaling using unlicensed spectrum.

FIG. 9 shows an example of a process flow that supports sidelink control signaling using unlicensed spectrum.

FIG. 10 shows a diagram of a system including a device that supports sidelink control signaling using unlicensed spectrum.

FIG. 11 shows a flowchart illustrating methods that support sidelink control signaling using unlicensed spectrum.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing third generation (3G), fourth generation (4G) or fifth generation (5G), or further implementations thereof, technology.

In some wireless communications systems, wireless devices may operate using an unlicensed radio frequency spectrum band that may be shared for access among one or more types of wireless devices. To mitigate communication collisions between wireless devices, such as interference between transmissions using the unlicensed spectrum, the wireless devices may be configured to perform a listen-before-talk (LBT) procedure before accessing a channel on the unlicensed spectrum (such as before performing a transmission on the unlicensed spectrum). In some implementations (such as implementations in accordance with one or more communications standards), some wireless devices may perform LBT procedures asynchronously whereas some other wireless devices may perform LBT procedure synchronously, such as in accordance with a slot boundary or some other interval. In some such implementations, wireless devices performing LBT procedures synchronously may be at a relative disadvantage when competing with wireless devices performing LBT procedures asynchronously for access to the unlicensed spectrum, because wireless devices performing LBT procedures synchronously may have fewer opportunities to contend for access. For example, a Wi-Fi Access Point (AP) may perform LBT procedures asynchronously, whereas a user equipment (UE) (such as a sidelink UE that is configured to support communications with one or more other UEs in accordance with a sidelink communications link or a device-to-device (D2D) communications link) may perform LBT procedures synchronously, which may limit opportunities for the UE to gain channel access for sidelink communications compared to the Wi-Fi AP.

To increase resource availability for sidelink communications, UEs may be configured to use resources that are available for certain transmissions, such as sidelink synchronization signal block (S-SSB) transmissions, to also transmit control signaling, such as one or more short control signals, which may be multiplexed with an S-SSB transmission in the frequency domain. In some implementations, such techniques may leverage a relaxed LBT sensing threshold associated with S-SSB transmissions, or leverage an LBT exemption or a clear channel exempt status associated with S-SSB transmissions, among other characteristics. In some implementations, control signaling for multiplexing with an S-SSB transmission may be configured to support certain types of signaling, such as using a short control signal to convey an indication of LBT failure or an LBT status, or to support detection of a radio link failure (RLF), such as at a receiving UE, among other information. Such techniques may increase an availability of an unlicensed spectrum to UEs performing sidelink communications, which may support control signaling that increases a reliability of sidelink communications among UEs communicating using an unlicensed spectrum.

Particular implementations of the subject matter described in this disclosure can be implemented to realize one or more of the following potential advantages. For example, as a result of multiplexing control signaling with an S-SSB transmission, a UE may increase sidelink communications continuity or reliability because the UE may have a higher likelihood of being able to access the unlicensed spectrum. Additionally, or alternatively, UEs may be able to leverage control signaling multiplexed with S-SSB transmissions to increase a likelihood of detecting LBT failure and initiating sidelink recovery mechanisms. Further, in some implementations, one or more UEs may belong to sidelink clusters, and such techniques for multiplexing control signaling with S-SSB transmissions may increase a likelihood of being able to transmit sidelink remaining minimum system information (S-RMSI) signals.

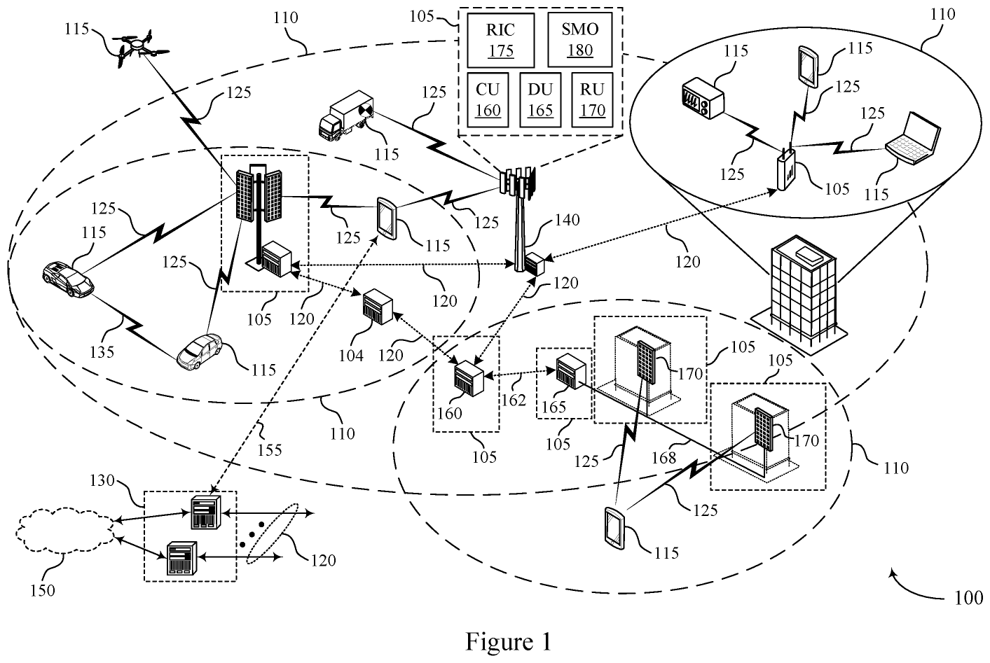

FIG. 1 shows an example of a wireless communications system 100 that supports sidelink control signaling using unlicensed spectrum. The wireless communications system 100 may include one or more network entities 105, one or more UEs 115, and a core network 130. In some implementations, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some implementations, network entities 105 and UEs 115 may wirelessly communicate via one or more communication links 125 (such as a radio frequency (RF) access link). For example, a network entity 105 may support a coverage area 110 (such as a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, network entities 105 may communicate with the core network 130, or with one another, or both. For example, network entities 105 may communicate with the core network 130 via one or more backhaul communication links 120 (such as in accordance with an S1, N2, N3, or other interface protocol). In some implementations, network entities 105 may communicate with one another via a backhaul communication link 120 (such as in accordance with an X2, Xn, or another interface protocol) either directly (such as directly between network entities 105) or indirectly (such as via a core network 130). In some implementations, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication links 120, midhaul communication links 162, or fronthaul communication links 168 may be or include one or more wired links (such as an electrical link, an optical fiber link), one or more wireless links (such as a radio link, a wireless optical link), among other examples or various combinations thereof. A UE 115 may communicate with the core network 130 via a communication link 155.

One or more of the network entities 105 described herein may include or may be referred to as a base station (BS) 140 (such as a base transceiver station, a radio BS, an NR BS, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some implementations, a network entity 105 (such as a BS 140) may be implemented in an aggregated (such as monolithic, standalone) BS architecture, which may be configured to utilize a protocol stack that is physically or logically integrated within a single network entity 105 (such as a single RAN node, such as a BS 140).

In some implementations, a network entity 105 may be implemented in a disaggregated architecture (such as a disaggregated BS architecture, a disaggregated RAN architecture), which may be configured to utilize a protocol stack that is physically or logically distributed among two or more network entities 105, such as an integrated access backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU) 160, a distributed unit (DU) 165, a radio unit (RU) 170, a RAN Intelligent Controller (RIC) 175 (such as a Near-Real Time RIC (Near-RT RIC), a Non-Real Time RIC (Non-RT RIC)), a Service Management and Orchestration (SMO) 180 system, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some implementations, one or more network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending upon which functions (such as network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (such as layer 3 (L3), layer 2 (L2)) functionality and signaling (such as Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (such as physical (PHY) layer) or L2 (such as radio link control (RLC) layer, medium access control (MAC) layer) functionality and signaling, and each may be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or more RUs 170). In some implementations, a functional split between a CU 160 and a DU 165, or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (such as F1, F1-c, F1-u), and a DU 165 may be connected to one or more RUs 170 via a fronthaul communication link 168 (such as open fronthaul (FH) interface). In some implementations, a midhaul communication link 162 or a fronthaul communication link 168 may be implemented in accordance with an interface (such as a channel) between layers of a protocol stack supported by respective network entities 105 that are in communication via such communication links.

In wireless communications systems (such as wireless communications system 100), infrastructure and spectral resources for radio access may support wireless backhaul link capabilities to supplement wired backhaul connections, providing an IAB network architecture (such as to a core network 130). In some implementations, in an IAB network, one or more network entities 105 (such as IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (such as a donor BS 140). The one or more donor network entities 105 (such as IAB donors) may be in communication with one or more additional network entities 105 (such as IAB nodes 104) via supported access and backhaul links (such as backhaul communication links 120). IAB nodes 104 may include an IAB mobile termination (IAB-MT) controlled (such as scheduled) by DUs 165 of a coupled IAB donor. An IAB-MT may include an independent set of antennas for relay of communications with UEs 115, or may share the same antennas (such as of an RU 170) of an IAB node 104 used for access via the DU 165 of the IAB node 104 (such as referred to as virtual IAB-MT (vIAB-MT)). In some implementations, the IAB nodes 104 may include DUs 165 that support communication links with additional entities (such as IAB nodes 104, UEs 115) within the relay chain or configuration of the access network (such as downstream). In such implementations, one or more components of the disaggregated RAN architecture (such as one or more IAB nodes 104 or components of IAB nodes 104) may be configured to operate according to the techniques described herein.

In the implementation of the techniques described herein applied in the context of a disaggregated RAN architecture, one or more components of the disaggregated RAN architecture may be configured to support sidelink control signaling using unlicensed spectrum as described herein. For example, some operations described as being performed by a UE 115 or a network entity 105 (such as a BS 140) may additionally, or alternatively, be performed by one or more components of the disaggregated RAN architecture (such as IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay BSs, among other examples, as shown in FIG. 1.

The UEs 115 and the network entities 105 may wirelessly communicate with one another via one or more communication links 125 (such as an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a BS 140, a CU 160, a DU 165, a RU 170) of a RAN communicating with another device (such as directly or via one or more other network entities 105).

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, for which the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some implementations, a UE 115 may be configured with multiple BWPs. In some implementations, a single BWP for a carrier may be active at a given time and communications for the UE 115 may be restricted to one or more active BWPs.

The time intervals for the network entities 105 or the UEs 115 may be expressed in multiples of a basic time unit which may, in some implementations, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as a quantity of symbol periods in a TTI) may be variable. Additionally, or alternatively, the smallest scheduling unit of the wireless communications system 100 may be dynamically selected (such as in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

In some implementations, a network entity 105 (such as a BS 140, an RU 170) may be movable and therefore provide communication coverage for a moving coverage area 110. In some implementations, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (such as BSs 140) may have similar frame timings, and transmissions from different network entities 105 may be approximately aligned in time. For asynchronous operation, network entities 105 may have different frame timings, and transmissions from different network entities 105 may, in some implementations, not be aligned in time. The techniques described herein may be used for either synchronous or asynchronous operations.

Some UEs 115, such as MTC or IoT devices, may be low cost or low complexity devices and may provide for automated communication between machines (such as via Machine-to-Machine (M2M) communication). M2M communication or MTC may refer to data communication technologies that allow devices to communicate with one another or a network entity 105 (such as a BS 140) without human intervention. In some implementations, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be configured to support communicating directly with other UEs 115 via a device-to-device (D2D) communication link 135 (such as in accordance with a peer-to-peer (P2P), D2D, or sidelink protocol). In some implementations, one or more UEs 115 of a group that are performing D2D communications may be within the coverage area 110 of a network entity 105 (such as a BS 140, an RU 170), which may support aspects of such D2D communications being configured by (such as scheduled by) the network entity 105. In some implementations, one or more UEs 115 of such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (such as UEs 115). In some implementations, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some implementations, vehicles in a V2X system may communicate with roadside infrastructure, such as roadside units, or with the network via one or more network nodes (such as network entities 105, BSs 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as BSs 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communication using UHF waves may be associated with smaller antennas and shorter ranges (such as less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some implementations, operations using unlicensed bands may be associated with a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a BS 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

Some implementations, such as V2X or other D2D implementations, may use sidelink communications for exchanging messages among UEs 115 configured to support sidelink communications, where UEs 115 in such a configuration may be referred to as sidelink UEs. In various implementations, a UE 115 may transmit sidelink messages using a licensed band, an unlicensed band, or both. In some implementations, such as deployments in the absence of direct control or management via a network entity, a UE 115 may operate in a sidelink resource allocation (RA) mode 2, for which a network entity 105 may indicate a resource pool and related configurations (such as using a pre-configuration). In RA mode 2, a UE 115 may utilize sensing and reservation for random channel access to transmit sidelink communications using the resource pool (such as a resource pool assigned to RA Mode 2). For example, the UE 115 may perform an LBT procedure to evaluate whether a sidelink channel is clear of transmissions from other devices, which may mitigate channel collisions and interference. In some implementations, UEs 115 performing sidelink communications may establish a unicast connection via a PC5-RRC protocol. A unicast connection may support hybrid automatic repeat request (HARQ) feedback, which a UE 115 may utilize for transmission-side detection of a radio link failure (RLF). For example, a transmitting UE 115 may detect a configured quantity of consecutive discontinuous transmission (DTX) communications from another UE 115, rather than valid HARQ responses, which the transmitting UE 115 may use to report an RLF to an upper layer (such as via a MAC layer). In some implementations, a UE 115 may utilize additional methods for performing sidelink communications such as discontinuous reception (DRX), partial sensing, and inter-UE coordination.

In some implementations, UEs 115 may perform sidelink communications over an unlicensed frequency band, such as an FR1 unlicensed band, which may involve UEs 115 competing with other devices for channel access. To support such techniques, a regulation or communications standard may be associated with coexistence mechanisms, such as listen-before-talk (LBT) procedures, to mitigate interference or communication collisions. For example, an initiating node may perform a Type 1 LBT to transmit data, which may be performed in accordance with operation in a dominating load-based-equipment (LBE) mode.

In some implementations, a UE 115 may perform synchronous channel access for sidelink communications using a configured interval, such as a configured TTI or slot boundary. For example, a receiving UE 115 may monitor for a physical sidelink control channel (PSCCH) (such as with fixed time-frequency location in a sub-channel) to identify a valid sidelink transmission. Accordingly, a transmitting UE 115 may transmit a PSCCH in accordance with a periodic timing in order for the transmission to be received successfully. However, some techniques for synchronization may limit opportunities for the UE 115 to gain channel access for sidelink transmissions. In some circumstances, a UE 115 may experience LBT failure when the UE 115 cannot gain channel access after repeated LBT attempts. The UE 115 may report the LBT failure to another wireless device, which may declare an RLF. By way of contrast, a Wi-Fi access point (AP) may perform asynchronous channel access, which may include immediately occupying a channel upon a successful Type 1 LBT operation. A UE 115, however, may perform channel access at a TTI boundary, such as a slot boundary, and a duration between TTI boundaries, or a duration between concluding a transmission and initiating a subsequent LBT operation, may be sufficient for a Wi-Fi AP to obtain a floating LBT such that a UE 115 may lose channel access for sidelink communications. Thus, in accordance with these and other examples, a Wi-Fi AP may have more opportunities to gain channel access, which may starve UEs 115 of channel access for sidelink communications.

In some implementations, a UE 115 may use a filler signal in order to occupy a channel of an unlicensed spectrum before a TTI boundary. Such techniques may be combined with a UE 115 using mini-slots, providing more opportunities for channel access for sidelink communications, which may improve coexistence with Wi-Fi APs. Additionally, or alternatively, UEs 115 may attempt to overcome channel starvation by sharing channel occupancy time, or using floating sidelink synchronization signal blocks (S-SSBs). However, such techniques may occupy processing and overhead resources.

To increase resource availability for sidelink communications, UEs 115 may be configured to use resources that are available for certain transmissions, such as S-SSB transmissions, to also transmit control signaling, such as one or more short control signals, which may be multiplexed with an S-SSB transmission in the frequency domain. In some implementations, such techniques may leverage a relaxed LBT sensing threshold associated with S-SSB transmissions, or leverage an LBT exemption or a clear channel exempt status associated with S-SSB transmissions, among other characteristics. In some implementations, control signaling for multiplexing with an S-SSB transmission may be configured to support certain types of signaling, such as using a short control signal to convey an indication of LBT failure or an LBT status, or to support detection of a RLF, such as at a receiving UE 115, among other information. Such techniques may increase an availability of an unlicensed spectrum to UEs performing sidelink communications, which may support control signaling that increases a reliability of sidelink communications among UEs using an unlicensed spectrum.

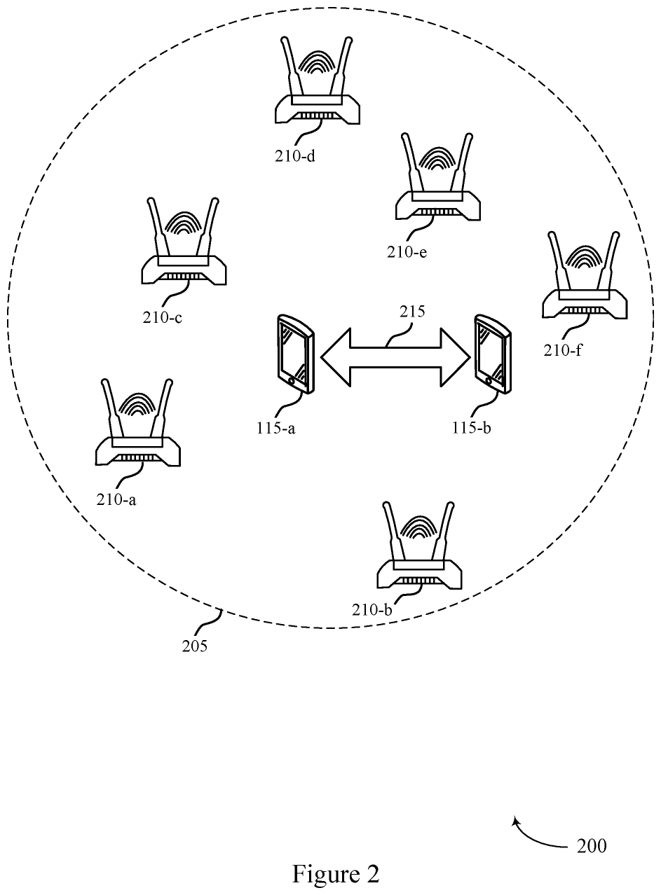

FIG. 2 shows an example of a signaling diagram 200 that supports sidelink control signaling using unlicensed spectrum. In some implementations, the signaling diagram 200 may illustrate an example of one or more aspects of the wireless communications system 100. For instance, a UE 115-a and a UE 115-b each may be an example of a UE 115 as described with reference to FIG. 1. The UE 115-a and the UE 115-b may be examples of UEs that are configured for sidelink communication using an unlicensed spectrum over a communications link 215, such as a unidirectional or bidirectional communications link, which may be an example of a PC5 interface. The UE 115-a and the UE 115-b may be located among APs 210, which also may operate using the unlicensed spectrum. The APs 210 may be examples of Wi-Fi access points, which may perform asynchronous channel access operations such as asynchronous LBT operations. The APs 210 and the UEs 115 of the signaling diagram may operate within an area 205, which may be associated with an energy detection (ED) threshold for LBT operations.

To facilitate spectrum access among the UEs 115 and the APs 210, a device attempting to perform a transmission may be configured to detect an energy of a frequency resource before performing the transmission, which may support the device evaluating the frequency resource for transmissions by other nodes. Using such an evaluation, the device may determine whether to perform a transmission using the frequency resource. For example, a UE 115 or an AP 210 may access a channel on the unlicensed spectrum after performing an LBT procedure. In some implementations, a UE 115 may perform an LBT procedure in accordance with a TTI timing, such as a slot timing, whereas an AP 210 may perform an LBT procedure without timing restrictions (such as preforming an LBT procedure asynchronously), and the UEs 115 and the APs 210 may refrain from accessing the channel unless a detected interference level is below an ED threshold (such as approximately negative seventy-two (−72) decibel-milliwatts (dBm)). In some implementations, LBT failure may occur as a result of a UE 115 being unable to gain access to the channel, which may be associated with the channel being occupied by other devices, such as other UEs 115 or other APs 210. A UE 115 may detect or initiate an LBT failure using a timer or a counter, and may report the failure to other devices of the network, such as another UE 115 or a network entity 105 (not shown), which may include declaring an RLF.

For some communications, the UEs 115 or the APs 210 may perform relaxed LBT sensing, which may be associated with a lower ED threshold, or an exemption from performing an LBT operation, such as when transmitting short control signaling. As used herein, a short control signaling transmission may refer to transmissions that are used by devices to convey management or control signaling, such as frames or other messages, without sensing a channel for the presence of other signals. For example, the APs 210 may be configured to transmit beacon signals after a Type 2 LBT, rather than a Type 1 LBT that may be used for other Wi-Fi communications. Further, a network entity 105 may be configured to transmit a demodulation reference signal DRS, such as in LAA or NR-U implementations, after a Type 2 LBT. In some implementations, the use of short control signaling transmissions may be associated with a communication standard, which may specify a quantity of short control signal transmissions during an observation period, or a duration of short control signaling transmissions during an observation period, or both. In some implementations, S-SSB transmissions by the UEs 115 may be characterized as or otherwise satisfy criteria for short control signaling, and may be specified in accordance with an SFN for timing propagation.

To reduce channel starvation, the UEs 115 may be configured to support multiplexing of short control signaling with S-SSB transmissions, which may include techniques for transmitting S-SSB signals in a non SFN-manner, such as having transmission timing that is not limited to SFN timing or not being limited to transmitting an indication of an SFN. For example, a UE 115 may be configured to support transmitting an S-SSB using a first resource of a channel of an unlicensed radio frequency spectrum band, and transmitting control signaling, such as a short control signal, using a second resource of the channel of the unlicensed radio frequency spectrum band. In some implementations, the control signaling may be frequency division multiplexed with the S-SSB. For example, a UE 115 may receive an indication of a resource pool for S-SSB transmissions, which also may be used for transmitting short control signaling that is frequency division multiplexed with an S-SSB transmission. The UE 115-a may transmit a S-SSB using a relaxed LBT threshold, or without performing an LBT operation. As such, the UE 115-a also may transmit the short control signaling with a relaxed LBT threshold, or without performing an LBT operation, such as when the short control signaling is multiplexed with the S-SSB.

In some implementations, the signaling diagram 200 may illustrate a system for which resources (such as resources for the short control signaling) are divided among multiple subchannels, which the UE 115-a may access in accordance with various procedures. For example, the UE 115-a may interlace short control signaling using a frequency resource of the channel that is non-contiguous with another frequency resource of the channel that is used for transmitting an S-SSB. In some other implementations, the UE 115-a may configure a subchannel randomly during one or more S-SSB occasions. In some implementations, UE 115-a may occupy a pattern of subchannels in accordance with a pre-defined pattern. Additionally, or alternatively, UE 115-a may implement a sensing or reservation mechanism to access one or more subchannels.

In some implementations, the UE 115-a and the UE 115-b may use short control signaling to support a recovery operation after a communications failure, such as an LBT failure, an RLF, or other loss or degradation of communication. For example, the UE 115-a and the UE 115-b may be configured to maintain the communications link 215 using short control signaling, which may involve responding to an LBT failure by activating a recovery mechanism, such as attempting communications using a different communications resource. Additionally, or alternatively, a UE 115 may implement short control signaling multiplexed with an S-SSB transmission to convey, to another UE 115, a status regarding LBT attempts, such as indicating a quantity of LBT attempts, which may support an early warning of risk of LBT failure. In some implementations, the UE 115-a and the UE 115-b may perform receiver-side RLF detection associated with short control signaling, which may be transmitted periodically. Additionally, or alternatively, the UEs 115 may use short control signaling multiplexed with S-SSB transmissions to support parallel sidelink clusters, or to relay S-RMSI, among other purposes.

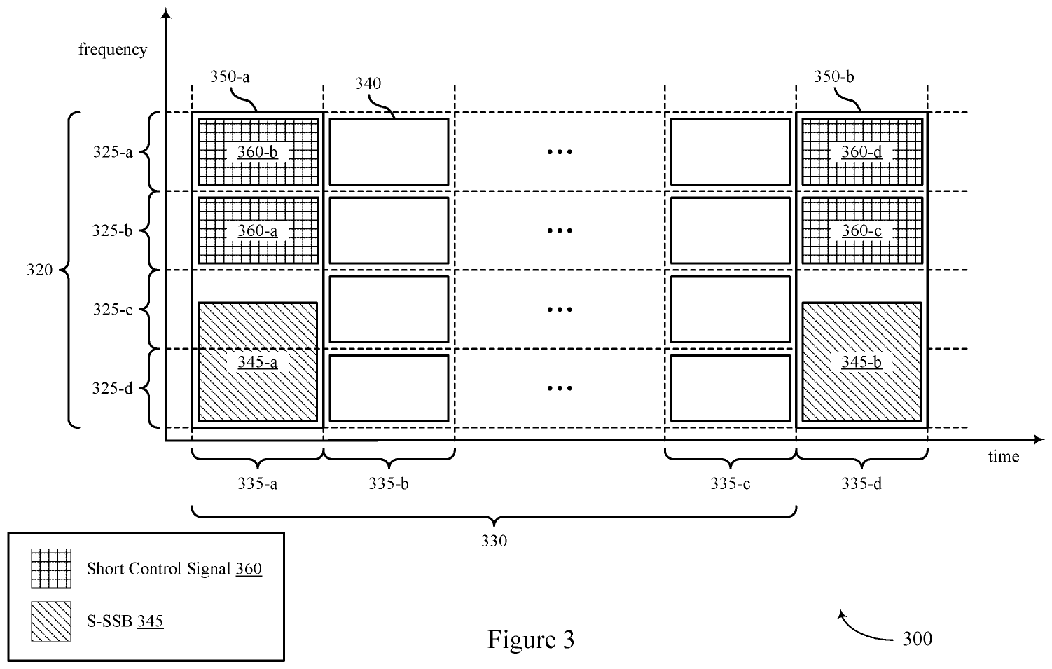

FIG. 3 shows an example of a resource configuration 300 that supports sidelink control signaling using unlicensed spectrum. The resource configuration 300 illustrates aspects of wireless communications that may be supported by the wireless communications system 100 or the signaling diagram 200 described with reference to FIGS. 1 and 2.

The resource configuration 300 illustrates an example of resources 340, which may refer to communication resources in the time domain, communication resources in the frequency domain, or both. For example, the resource configuration 300 may be implemented for one or more channels 320 in the frequency domain, and for one or more configuration intervals 330 in the time domain. In the time domain, each resource 340 may be associated with a respective transmission interval 335, such as a slot, a mini slot, or other transmission interval or transmission interval index. Each of the transmission intervals 335 may be associated with one or more TTIs in accordance with a communications configuration. In some implementations, aspects of the resources 340 for a transmission interval 335 may be specified in accordance with a resource set 350, which may involve a specification of one or more transmission intervals 335 by an indication of a parameter SSB TimeAllocationX, X∈{1,2,3}. In the frequency domain, each resource 340 may be associated with a respective subchannel 325, which each may be a portion of the channel 320, such as a control subchannel. A channel 320 may refer to a channel of an unlicensed spectrum, and the configuration interval 330 may refer to a resource configuration interval, such as a duration of applicability or a duration of repetition, which may be a duration configured by a communications standard or a duration configured by a network entity 105, such as an interval of 160 ms or another integer multiple of TTIs. The resource configuration 300, or one or more resource sets 350, or a set of one or more resources 340 may be examples of resource pools that may be available for use by a UE 115, such as a sidelink UE 115.

In some implementations, such as when operating using an unlicensed band associated with LBT operations, a UE 115 may receive a configuration of such a resource pool, which may indicate opportunities, such as resources 340 or transmission intervals 335, that are available for transmitting control signaling that is frequency-division multiplexed with an S-SSB transmission. For example, a UE 115 may receive, from a network entity 105, an indication of one or more aspects of the resource configuration 300, which may refer to resources 340 of an unlicensed radio frequency spectrum band. Using resources 340, a UE 115 may transmit one or more short control signals 360 concurrently with an S-SSB 345 in accordance with relaxed LBT sensing, including such transmission after a Type 2 LBT, or an LBT exemption.

In some implementations, a UE 115 may receive an indication of a configuration for how to access a subchannel 325, or an indication of what may be transmitted using a given subchannel 325 or resource 340, or any combination thereof, which may include an indication that such transmissions may be performed in a non-SFN manner. For example, some of the resources 340 may be available for transmitting an S-SSB 345, and some of the resources 340 may be available for transmission of one or more short control signals 360. In an illustrative example, a UE 115 may transmit an S-SSB 345-a during the transmission interval 335-a using the subchannels 325-c and 325-d, and may transmit a short control signal 360-a and a short control signal 360-b during the same transmission interval 335-a using the subchannels 325-b and 325-a, respectively. As such, the UE 115 may transmit the short control signals 360-a and 360-b and an S-SSB 345-a in accordance with a transmission interval 335-a, or TTI thereof, of the resource configuration 300, or otherwise in accordance with the resource set 350-a. Resources 340 may be configured in accordance with various patterns, which may support interlacing a short control signal 360 using a resource 340 that is non-contiguous with a resource 340 used for transmitting an S-SSB 345.

A UE 115 may access one or more resources 340 for sidelink communications in accordance with various techniques. In some implementations, a UE 115 may select a resource 340 using a device identifier (such as a UE identifier, a group identifier, a pseudo-identifier), an index of a transmission interval 335, an index of a TTI, or a combination thereof. Additionally, or alternatively, a UE 115 may be configured to access a randomly-selected subchannel 325 or resource 340, including such a selection during at least one S-SSB occasion, or each S-SSB occasion in which the UE 115 is attempting to access, which may refer to one or more of the transmission intervals 335 of the configuration interval 330. In some implementations, a UE 115 may perform a hash function that uses a identifier associated with the UE 115 and an index of a transmission interval 335, such as a slot index, as inputs to determine an index of a subchannel 325.

In some implementations, a UE 115 may occupy a pattern of subchannels 325, such as a pattern in the frequency domain, a pattern in the time domain, or both, which may include a predefined set specified in an L3 configuration or other configuration. In some implementations, accessing a pattern of subchannels 325 can be leveraged by a performing a sensing and reservation procedure, which may be simplified relative to other sensing and reservation procedures. For example, a short control signal 360 may carry an indication, such as a low-bit indication, of whether a transmission using one or more resources 340 is periodic or otherwise repeating, or is associated with a single channel use. In some implementations, including circumstances in which transmission of short control signals 360 is periodic or otherwise repeating, the UE 115 may sense (such as via received signal strength indicator (RSSI) measurement, which may be an alternative to sidelink control information (SCI) decoding) an associated pool of subchannels 325 for a duration before occupying a pattern of subchannels 325. Additionally, or alternatively, a UE 115 may perform a sensing or reservation mechanism in accordance with a Mode 2 based resource pool.

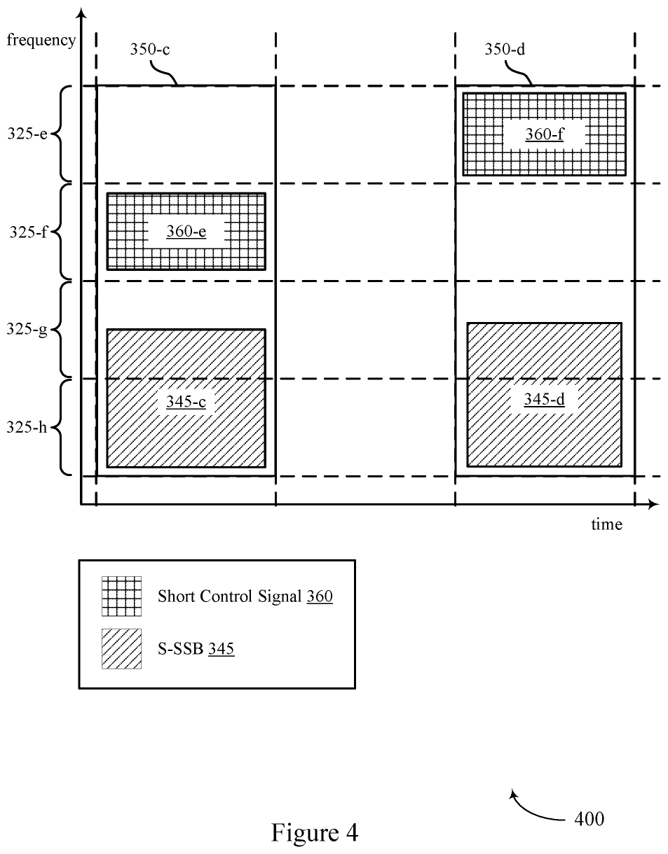

FIG. 4 shows an example of a resource configuration 400 that supports sidelink control signaling using unlicensed spectrum. The resource configuration 400 may be an example of aspects of the resource configuration 300 described with reference to FIG. 3, and may illustrate aspects of wireless communications that may be supported by the wireless communications system 100 or the signaling diagram 200 described with reference to FIGS. 1 and 2. In some implementations, the resource sets 350 of the resource configuration 400 may be allocated (such as an allocation by a network entity 105) for use by UEs 115 for transmitting short control signals 360 that are multiplexed in the frequency domain with a transmission of an S-SSB 345. For example, the resources set 350-c may correspond to a parameter sl-SSBTimeAllocation1 and the resource set 350-d may correspond to a parameter sl-SSBTimeAllocation2.

The resource configuration 400 may be implemented by UEs 115, such as sidelink UEs 115-a and 115-b described with reference to FIG. 2, which may maintain a communications link, such as a bidirectional signaling link or a sidelink, over subchannels 325 or other resources in the frequency domain. In some implementations, the resource configuration 400 may be implemented to handle an LBT failure in accordance with a sidelink RA Mode 2, such as when one or both of the UEs 115-a or 115-b are unable to access a channel of an unlicensed spectrum. For example, a resource pool associated with the resource configuration 400 may support transmission of one or more S-SSBs 345 with a relaxed threshold on reference signal received power (RSRP) from a current sync source (such as while under a risk of LBT failure even when the UEs 115-a and 115-b are close to each other), or an exemption from performing an LBT procedure.

If conditions of an LBT failure are satisfied, a UE 115 supporting sidelink communications (such as the UE 115-a or the UE 115-b) may send an LBT failure indication using a short control signal 360 that is multiplexed with an S-SSB 345, which may include an indication of a recovery mechanism. For example, if the sidelink UE 115-a identifies an LBT failure, the UE 115-a may transmit an indication of the LBT failure in a short control signal 360-e that is multiplexed with an S-SSB 345-c. Additionally, or alternatively, if the UE 115-b identifies an LBT failure, the UE 115-b may transmit an indication of the LBT failure in a short control signal 360-f that is multiplexed with an S-SSB 345-d. In some other examples, if the UE 115-b receives the short control signal 360-e, which may indicate an LBT failure as identified by the UE 115-a, the sidelink UE 115-b may transmit a response, such as a recovery signal, using a short control signal 360-f that is multiplexed with the S-SSB 345-d.

In various implementations, an indication of an LBT failure may trigger a receiving UE 115 to initiate a recovery mechanism, such as a recovery mechanism that is understood among UEs 115 performing sidelink communications. In some implementations, a recovery mechanism may include a frequency domain response, such as hopping to another frequency resource of the unlicensed spectrum to reestablish a connection. Additionally, or alternatively, a recovery mechanism may include a spatial domain response, which may include the UEs 115 attempting a recover a connection in a different beam space that may have less interference from other RATs. Additionally, or alternatively, a recovery mechanism may include a time domain response, which may include the UEs 115 attempting to recover a connection with support of a more robust channel access as floating channel occupancy time transmission.

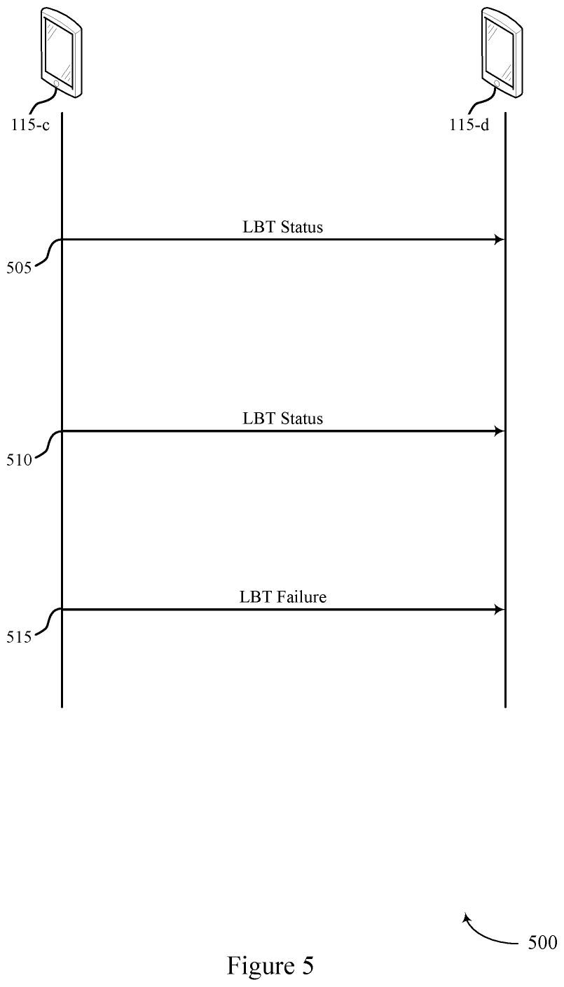

FIG. 5 shows an example of a process flow 500 that supports sidelink control signaling using unlicensed spectrum. The process flow 500 may implement or be implemented by aspects of the wireless communication systems 100 and signaling diagram 200 as described with reference to FIGS. 1 and 2, respectively. For example, the process flow 500 may be implemented by a UE 115-c and a UE 115-d, which may be examples of a UE 115 as described with reference to FIGS. 1 and 2. In the following description of the process flow 500, the operations between the UE 115-c and the UE 115-d may be transmitted in a different order than the example order shown, or the operations performed may be performed in different orders or at different times. Some operations also may be omitted from the process flow 500, and other operations may be added to the process flow 500.

In the example of process flow 500, the UE 115-c may use one or more short control signals, such as a short control signal 360 described with reference to FIGS. 3 and 4, to indicate an LBT status to the UE 115-d, which may support an early warning of a risk of LBT failure. Specifically, the UE 115-c may signal an LBT status to the UE 115-d at 505, at 510, or at both 505 and 510 as part of a periodic transmission. A short control signal of 505 or 510 may be frequency division multiplexed with a S-SSB, which may support performing a relaxed LBT procedure or an LBT exemption.

An LBT status indication of the process flow 500 may include various indications. In some implementations, an LBT status indication at 505 or 510 may include statistics on LBT attempts (such as an indication of total quantity of attempts, or an indication of a quantity of failed attempts), including those for transmitting S-SSB, for transmitting broadcasting or groupcasting, or for transmitting unicast transmissions (such as for a third UE 115, not shown), or any combination thereof, among other examples. Additionally, or alternatively, an LBT status indication by the UE 115-c may include statistics on LBT attempts made specifically to support transmissions to the UE 115-d. Additionally, or alternatively, an LBT status indication by the UE 115-c may include statistics on LBT failures due to other RATs, such as LBT failures due to detected Wi-Fi transmissions. In various implementations, an LBT status indication of 505 or 515 may support a preemptive recovery to improve resource availability for sidelink communications between the UE 115-c and the UE 115-d, such as an indication of an alternative or candidate communication resource (such as an indication of candidate frequency domain resource, or a candidate time domain resource, or a candidate spatial resource, or a candidate RAT, or any combination thereof). In some implementations, the UE 115-c may transmit an indication of LBT failure at 515, which may trigger a recovery mechanism as described with FIG. 4, which may include an indication to proceed with one or more aspects of a recovery mechanism indicated in an LBT status indication of 505 or 510.

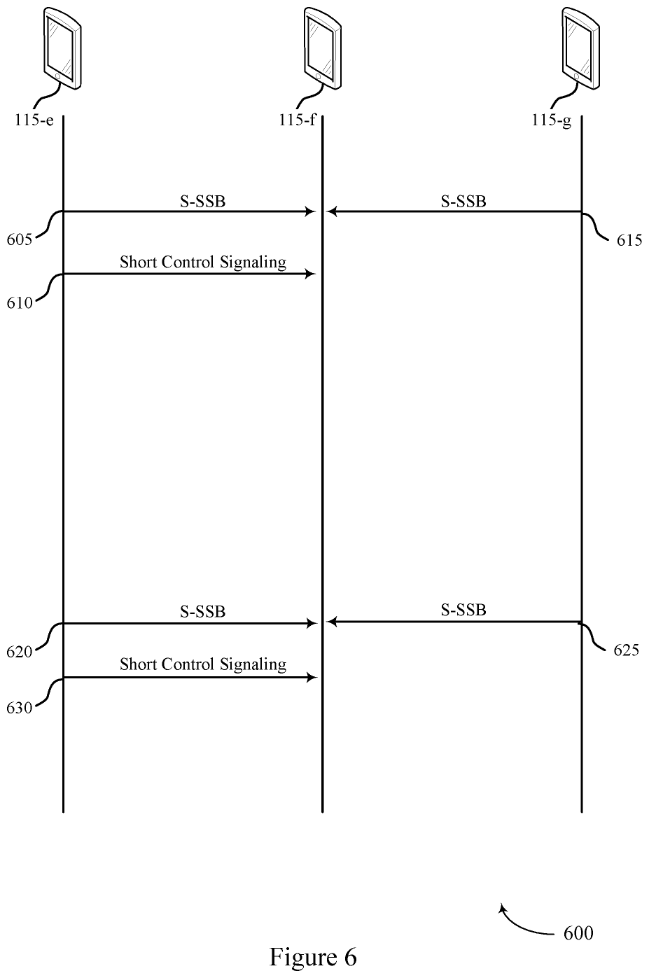

FIG. 6 shows an example of a process flow 600 that supports sidelink control signaling using unlicensed spectrum. The process flow 600 may illustrate an example of using short control signaling of an unlicensed spectrum to perform receiver-side RLF detection. In some implementations, the process flow 600 may implement or be implemented by aspects of the wireless communication systems 100 and signaling diagram 200 as described with reference to FIGS. 1 and 2, respectively. For example, the process flow 600 may be implemented by a UE 115-e, a UE 115-f, and a UE 115-g, which may be examples of a UE 115 as described with reference to FIGS. 1 and 2. In the following description of the process flow 600, the operations between the UE 115-e, the UE 1154, the UE 115-g may be transmitted in a different order than the example order shown, or the operations performed may be performed in different orders or at different times. Some operations also may be omitted from the process flow 600, and other operations may be added to the process flow 600.

In some implementations, the UE 115-e and the UE 115-g may be synchronized, which may include both the UE 115-e and the UE115-g transmitting S-SSBs (such as S-SSB transmissions as illustrated at 605, at 615, at 620, and at 625). The S-SSB transmissions by the UEs 115-e and 115-g may each include an SFN, which may be common between transmission of the UEs 115-e and 115-g. Thus, in some instances, the UE 115-f may not be able to distinguish between an S-SSB transmissions of the UE 115-e and an S-SSB transmission of the 115-g, which may be associated with such S-SSB transmissions being unsuitable for the UE 115-f to evaluate RLF conditions of the UE 115-e and the UE 115-g.

In the example of process flow 600, UEs 115 may be configured to perform receiver-side RLF detection using measurements of periodically transmitted short control signaling from other UEs 115, which may be multiplexed with S-SSB transmissions in accordance with examples as disclosed herein. For instance, the UE 115-f may monitor for periodic short control signaling from at least the UE 115-e, such as at 610 and 630. If a link quality evaluated from measuring such short control signaling drops below a threshold (such as RSRP or reference signal received quality (RSRQ)), the UE 115-f may detect an RLF. In some implementations, the UE 115-f also may be able to perform receiver-side RLF detection for the UE 115-g, which may leverage short control signals from the UE 115-g having an indication unique to the UE 115-g, such as a UE identifier, or may leverage short control signals from the UE 115-g that are not transmitted concurrently with the short control signaling of 610 and 630, among other examples.

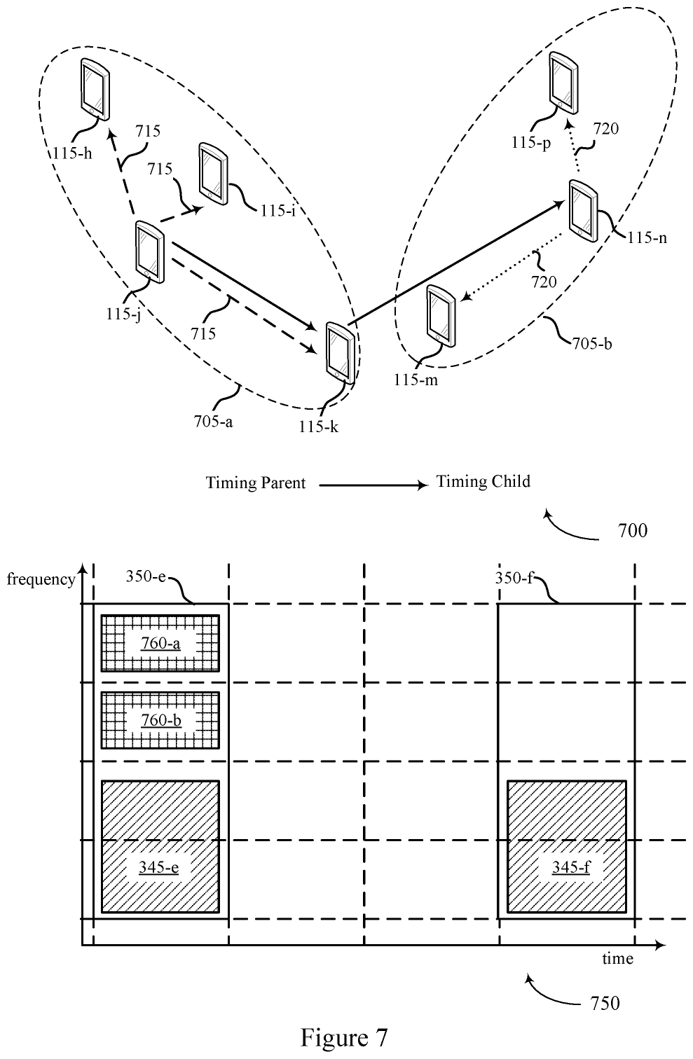

FIG. 7 shows an example of a signaling diagram 700 and a resource configuration 750 that supports sidelink control signaling using unlicensed spectrum. The signaling diagram 700 may be an example of one or more aspects of wireless communications system 100 and signaling diagram 200. For instance, the UE 115-h, the UE 115-i, the UE 115-j, the UE 115-k, the UE 115-m, the UE 115-n, and the UE 115-p each may be an example of a UE 115 as described with reference to FIGS. 1 and 2.

The UE 115-j may operate as a hub for a sidelink cluster 705-a, which includes the leaf UEs 115-h, 115-i, 115-j, and 115-k. In some implementations, the UE 115-j may broadcast control information 715, such as an S-SSB or S-RMSI, which may be received by the leaf UEs 115-h, 115-i, and 115-k, to support managing aspects of the sidelink cluster 705-a. The UE 115-n may operate as a hub for a sidelink cluster 705-b, which includes the leaf UEs 115-m, 115-n, and 115-p. In some implementations, the UE 115-n may broadcast control information 720, such as an S-SSB or S-RMSI, which may be received by the leaf UEs 115-m and 115-p, to support managing aspects of the sidelink cluster 705-b.

In some implementations, resource pools that support multiplexing short control signals with S-SSB transmissions may be leveraged to support the sidelink cluster 705-a and the sidelink cluster 705-b operating as parallel sidelink clusters with the same sidelink timing or otherwise related sidelink timing. For example, transmission of S-SSBs may be performed with relaxed LBT sensing or an LBT exemption, and it may be beneficial for the sidelink clusters 705-a and 705-b to support transmission of S-RMSI in a similar manner.

In an illustrative example, the UE 115-j may be a timing parent of the UE 115-k, and the UE 115-k may be a timing parent of the UE 115-n. As part of the parallel operation of the sidelink clusters 705-a and 705-b, the UEs 115-j and 115-n may transmit during the same transmission interval 335, such as using the same resource set 350-e, which may be defined at least in part by the parameter sl-SSBTimeAllocation1. In such an example, the UE 115-j and the UE 115-n each may transmit an S-SSB 345-e using a symbol frame number, and may transmit respective S-RMSI signals on different subchannels 325. For example, the UE 115-j may transmit an S-RMSI 760-a and the UE 115-n may transmit an S-RMSI 760-b. In some implementations, the UE 115-k may transmit the S-SSB 345-f during a different transmission interval 335, such as using the resource set 350-f, which may be multiplexed with other short control signaling or may omit other short control signaling (such as omitting S-RMSI). Is this way, both UEs 115-j and 115-n may be less susceptible to LBT blocking when transmitting a S-RMSI.

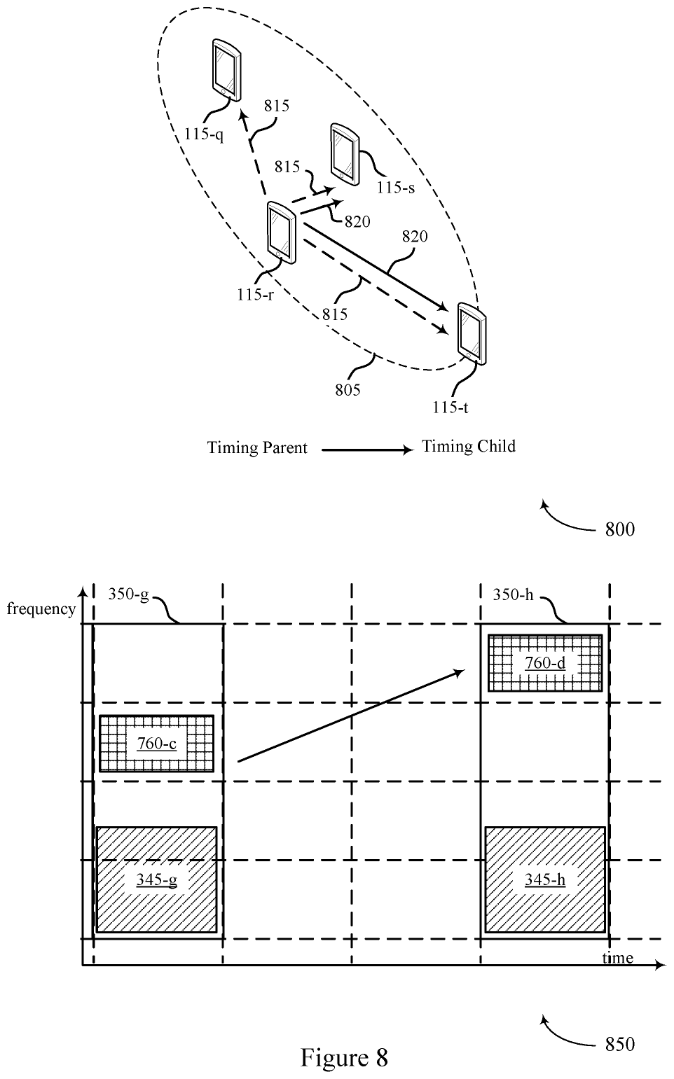

FIG. 8 shows an example of a signaling diagram 800 and a resource configuration 850 that supports sidelink control signaling using unlicensed spectrum. The signaling diagram 800 may be an example of one or more aspects of wireless communications system 100 and signaling diagram 200. For instance, the UE 115-q, the UE 115-r, the UE 115-s, the UE 115-t each may be an example of a UE 115 as described with reference to FIGS. 1 and 2. The UE 115-r may be a hub for a sidelink cluster 805, for which UEs 115-q, 115-s, and 115-t may operate as leaf UEs.

In some implementations, the UE 115-r may broadcast control information 815, such as an S-SSB or S-RMSI, which may be received by the UEs 115-q, 115-s, and 115-t, to support managing aspects of the sidelink cluster 805. To support operation in a star topology, the hub UE 115-r may implement relaying of the control information 815 using selected leaf UEs 115, which may support a relatively large footprint of the sidelink cluster 805. For example, the UE 115-r may use the UE 115-s and the UE 115-t to operate as a synch-UE, which may involve relaying SLSS, or S-RMSI, or both, among other control signaling. To support such techniques, the UE 115-r may arrange transmission of control signaling, such as S-RMSI, by the UEs 115-s and 115-t using short control signals 360, which may include an SFN-based transmission that may be arranged using network layer, such as a layer 3 (L3) protocol. In some implementations, such as when a per-occasion random subchannel selection is used, the UE 115-r may indicate (such as request, via an indication 820) that the UE 115-s and the UE 115-t use a same identifier (such as a common identifier, an identifier of the UE 115-r, a pseudo identifier, a group identifier) in a hashing function for selecting a resource 340 or a subchannel 325, which may support one or more transmissions of the UEs 115-s and 115-t using common resources 340. In an illustrative example, the UE 115-r may transmit an S-RMSI 760-c multiplexed with an S-SSB 345-g using a resource set 350-g, and the UEs 115-s and 115-t each support a relay of at least a portion of the S-RMSI 760-c by transmitting an S-RMSI 760-d that is multiplexed with an S-SSB 345-h using a resource set 350-h. In some implementations, the UE 115-r may assign a same resource pattern to the relaying UEs 115-s and 115-t (such as implementations in which a pre-defined pattern is used).

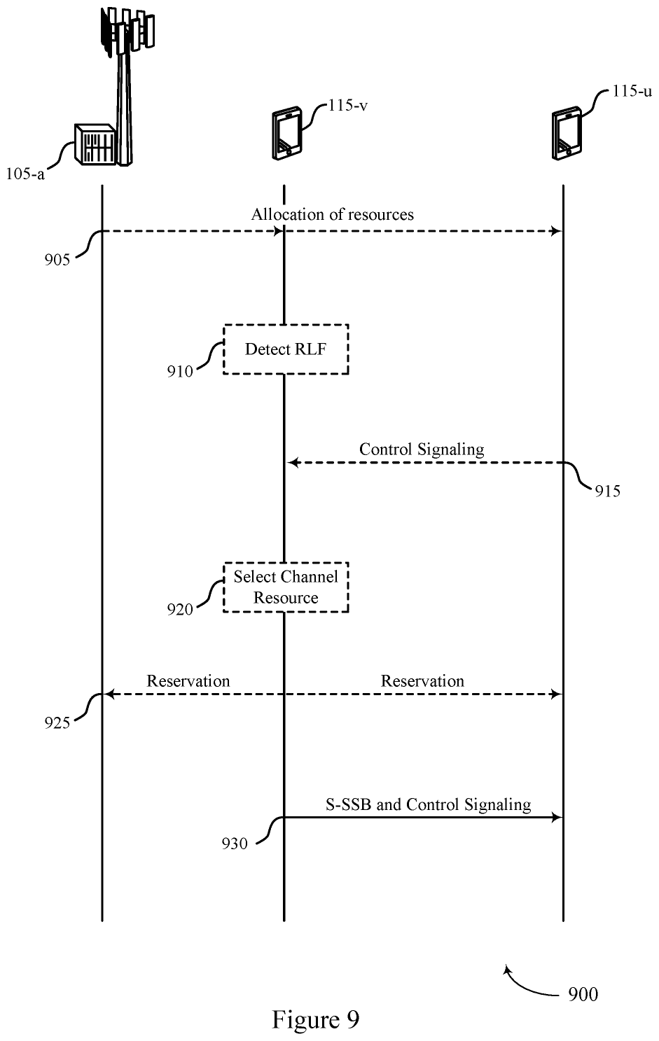

FIG. 9 shows an example of a process flow 900 that supports sidelink control signaling using unlicensed spectrum. In some implementations, the process flow 900 may implement or be implemented by aspects described in FIGS. 1-8. For example, aspects of the process flow 900 may be implemented by a UE 115-v and a UE 115-u, which may be examples of a UE 115 as described with reference to FIGS. 1 and 2. In some implementations, aspects of the process flow 900 may be implemented by a network entity 105-a, which may be an example of a network entity 105 as described with reference to FIG. 1. In the following description of the process flow 900, the operations between the UE 115-v, the UE 115-u, the network entity 105-a may be transmitted in a different order than the example order shown, or the operations performed may be performed in different orders or at different times. Some operations also may be omitted from the process flow 900, and other operations may be added to the process flow 900.

At 930, the UE 115-v may transmit a S-SSB using a resource of a channel of an unlicensed radio frequency band. The UE 115-v also may transmit control signaling using a second resource of the channel of the unlicensed radio frequency spectrum band. In some implementations, the control signaling may be frequency division multiplexed with the S-SSB. In some implementations, the UE 115-v may interlace the control signaling using a frequency resource that is non-contiguous with the frequency resource of the channel used for transmitting the S-SSB. In some implementations, the control signaling may be associated with a broadcast transmission. Additionally, or alternatively, the control signaling may include an indication of a device identifier for performing a resource selection.

A S-SSB transmission may be exempt from LBT procedures (such that the UE 115-v may transmit a S-SSB without performing an LBT procedure or the UE 115-v may transmit the S-SSB after performing a relaxed LBT procedure). As such, the UE 115-v also may be exempt from performing an LBT procedure when transmitting the control signaling that is multiplexed with the S-SSB. In some implementations, the UE 115-v may transmit the multiplexed control signaling as a result of an LBT failure. For example, if the UE 115-v experiences LBT failure, the control signaling may be transmitted to the UE 115-u, which may trigger a recovery mode. As such, the UE 115-v and the UE 115-u may recover a connection by switching to a different sub-band, switching to a different beam space, or use a more robust channel among other recovery methods.

In some implementations, the UE 115-v may perform the signaling at 930 in accordance with a RLF detected with another sidelink device at 910. Additionally, or alternatively, the UE 115-v may perform the signaling at 930 in accordance with control signaling received from the UE 115-u at 915. For example, the UE 115-v may measure control signaling of 915 and may perform the signaling at 930 if a signal quality signaling at 915 is below a threshold.

In some implementations, the UE 115-v may perform the signaling at 930 in accordance with an allocation of resources, which may include a resource selection, including a selection associated with the detected RLF failure at 910 or the signaling at 915, among other examples. For example, the UE 115-u and the UE 115-v may receive, from the network entity 105-a, an indication of an allocation of resources of the unlicensed radio frequency spectrum band at 905. The allocation of resources may indicate a resource, or a TTI, or both for performing the signaling of 930. Additionally, or alternatively, at 920, the UE 115-v may select one or more resource of the channel according to a device identifier on an index of the TTI, and also may reserve the selected resources at 925 by transmitting a signal (such as a broadcast signal) to the network entity 105-a, to the UE 115-u, or both.

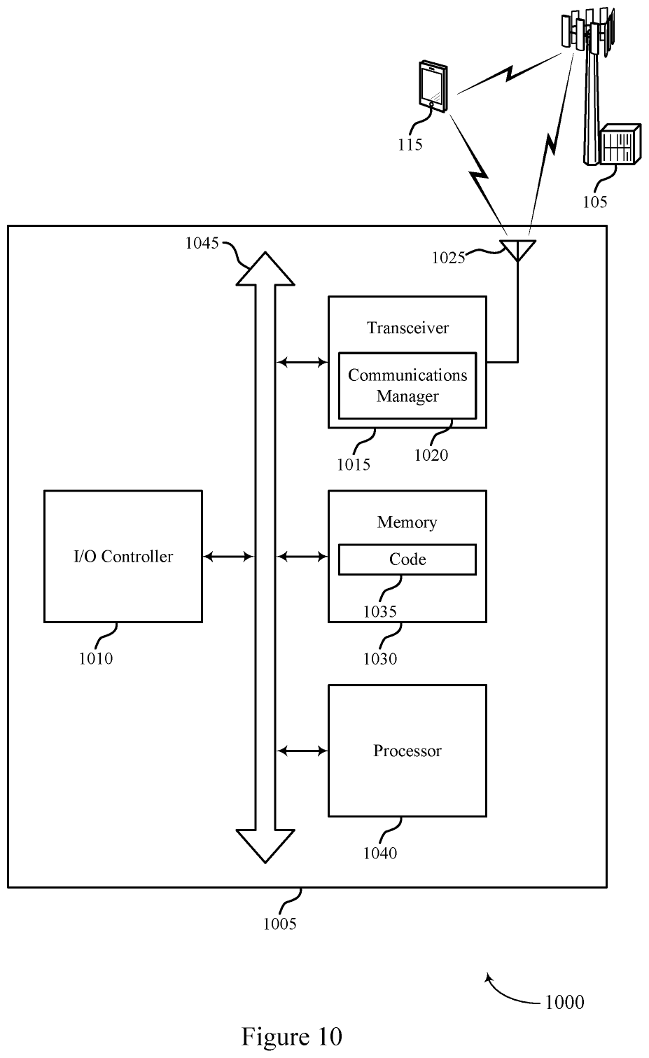

FIG. 10 shows a diagram of a system 1000 including a device 1005 that supports sidelink control signaling using unlicensed spectrum. The device 1005 may communicate (such as wirelessly) with one or more network entities (such as one or more components of one or more network entities 105), one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (such as operatively, communicatively, functionally, electronically, electrically) via one or more buses (such as a bus 1045).

The I/O controller 1010 may manage input and output signals for the device 1005. The I/O controller 1010 also may manage peripherals not integrated into the device 1005. In some implementations, the I/O controller 1010 may represent a physical connection or port to an external peripheral. In some implementations, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some implementations, the I/O controller 1010 may be implemented as part of a processor or processing system, such as the processor 1040. In some implementations, a user may interact with the device 1005 via the I/O controller 1010 or via hardware components controlled by the I/O controller 1010.

In some implementations, the device 1005 may include a single antenna 1025. However, in some other implementations, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 also may include a modem to modulate the packets, to provide the modulated packets to one or more antennas 1025 for transmission, and to demodulate packets received from the one or more antennas 1025. In some implementations, the transceiver 1015 may include one or more interfaces, such as one or more interfaces coupled with the one or more antennas 1025 that are configured to support various receiving or obtaining operations, or one or more interfaces coupled with the one or more antennas 1025 that are configured to support various transmitting or outputting operations, or a combination thereof. In some implementations, the transceiver 1015 may include or be configured for coupling with one or more processors or memory components that are operable to perform or support operations using received or obtained information or signals, or to generate information or other signals for transmission or other outputting, or any combination thereof. In some implementations, the transceiver 1015, or the transceiver 1015 and the one or more antennas 1025, or the transceiver 1015 and the one or more antennas 1025 and one or more processors or memory components (such as the processor 1040, or the memory 1030, or both), may be included in a chip or chip assembly that is installed in the device 1005.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some implementations, the code 1035 may not be directly executable by the processor 1040 but may cause a computer (such as when compiled and executed) to perform functions described herein. In some implementations, the memory 1030 may contain, among other things, a basic I/O system (BIOS) which may control basic hardware or software operation such as the interaction with peripheral components or devices.

The processor 1040 may be any one or more suitable processors capable of executing scripts or instructions of one or more software programs stored in the device 1005 (such as within the memory 1030). In some implementations, the processor 1040 may be a component of a processing system. A processing system may generally refer to a system or series of machines or components that receives inputs and processes the inputs to produce a set of outputs (which may be passed to other systems or components of, for example, the device 1005). For example, a processing system of the device 1005 may refer to a system including the various other components or subcomponents of the device 1005, such as the processor 1040, or the transceiver 1015, or the communications manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1005 may transmit information output from the chip or modem. Additionally, or alternatively, in some implementations, the one or more interfaces may refer to an interface between the processing system of the chip or modem and a receiver, such that the device 1005 may obtain information or signal inputs, and the information may be passed to the processing system. A person having ordinary skill in the art will readily recognize that a first interface also may obtain information or signal inputs, and a second interface also may output information or signal outputs.

The communications manager 1020 may support wireless communication in accordance with examples as disclosed herein. For example, the communications manager 1020 may be configured as or otherwise support a means for transmitting a sidelink synchronization signal block (SSB) using a first resource of a channel of an unlicensed radio frequency spectrum band, and transmitting control signaling using a second resource of the channel of the unlicensed radio frequency spectrum band. In some implementations, the control signaling may be frequency-division multiplexed with the SSB.

In some implementations, the communications manager 1020 may be configured as or otherwise support a means for receiving an indication of an allocation of resources of the unlicensed radio frequency spectrum band, and transmitting the control signaling using the second resource may be in accordance with the allocation of resources.

In some implementations, transmitting the control signaling may be in accordance with a TTI associated with the allocation of resources.

In some implementations, the communications manager 1020 may be configured as or otherwise support a means for selecting the second resource of the channel according to a device identifier, on an index of a TTI associated with transmitting the control signaling, or a combination thereof.

In some implementations, the communications manager 1020 may be configured as or otherwise support a means for transmitting a signal to reserve the second resource of the channel.

In some implementations, the control signaling may include an indication of an LBT failure, an indication of a quantity of LBT attempts, or a combination thereof.

In some implementations, the communications manager 1020 may be configured as or otherwise support a means for detecting a RLF with another sidelink device, and transmitting the control signaling may be associated with the RLF.

In some implementations, the control signaling may include an indication to recover a sidelink communication link using a second channel of the unlicensed radio frequency spectrum band.

In some implementations, the communications manager 1020 may be configured as or otherwise support a means for receiving second control signaling from another sidelink device, and transmitting the control signaling may be associated with a signal quality measurement of the second control signaling satisfying a threshold.

In some implementations, transmitting the control signaling frequency-division multiplexed with the SSB may be associated with an LBT exemption.

In some implementations, transmitting the control signaling frequency-division multiplexed with the SSB may be associated with an LBT failure.

In some implementations, to support transmitting the control signaling, the communications manager 1020 may be configured as or otherwise support a means for interlacing the control signaling using a second frequency resource of the channel that is non-contiguous with a first frequency resource of the channel associated with transmitting the SSB.

In some implementations, the control signaling may be associated with a broadcast transmission.

In some implementations, the control signaling may include an indication of a device identifier for performing a resource selection.

In some implementations, the communications manager 1020 may be configured to perform various operations (such as receiving, monitoring, transmitting) using or otherwise in cooperation with the transceiver 1015, the one or more antennas 1025, or any combination thereof. Although the communications manager 1020 is illustrated as a component of the transceiver 1015, in some implementations, one or more functions described with reference to the communications manager 1020 may be supported by or performed by the transceiver 1015, the processor 1040, the memory 1030, the code 1035, or any combination thereof. For example, the code 1035 may include instructions executable by the processor 1040 to cause the device 1005 to perform various aspects of sidelink control signaling using unlicensed spectrum as described herein, or the processor 1040 and the memory 1030 may be otherwise configured to perform or support such operations.

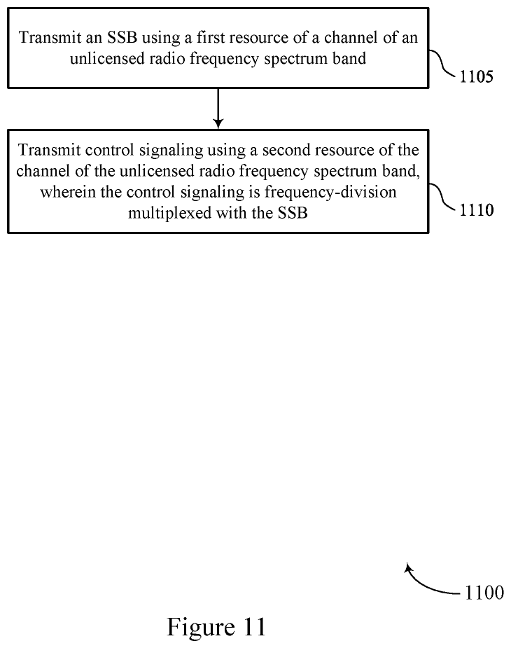

FIG. 11 shows a flowchart illustrating a method 1100 that supports sidelink control signaling using unlicensed spectrum. The operations of the method 1100 may be implemented by a UE or its components as described herein. For example, the operations of the method 1100 may be performed by a UE 115 as described with reference to FIGS. 1-10. In some implementations, a UE may execute a set of instructions to control the functional elements of the UE to perform the described functions. Additionally, or alternatively, the UE may perform aspects of the described functions using special-purpose hardware.

At 1105, the method may include transmitting a sidelink synchronization signal block (SSB) using a first resource of a channel of an unlicensed radio frequency spectrum band. The operations of 1105 may be performed in accordance with examples as disclosed herein.

At 1110, the method may include transmitting control signaling using a second resource of the channel of the unlicensed radio frequency spectrum band, where the control signaling is frequency-division multiplexed with the SSB. The operations of 1110 may be performed in accordance with examples as disclosed herein.

The following provides an overview of some aspects of the present disclosure:
Aspect 1: A method for wireless communication, including: transmitting a sidelink SSB using a first resource of a channel of an unlicensed radio frequency spectrum band; and transmitting control signaling using a second resource of the channel of the unlicensed radio frequency spectrum band, where the control signaling is frequency-division multiplexed with the SSB.
Aspect 2: The method of aspect 1, further including: receiving an indication of an allocation of resources of the unlicensed radio frequency spectrum band, where transmitting the control signaling using the second resource is in accordance with the allocation of resources.
Aspect 3: The method of aspect 2, where transmitting the control signaling is in accordance with a TTI associated with the allocation of resources.
Aspect 4: The method of any of aspects 1 through 3, further including: selecting the second resource of the channel according to a device identifier, on an index of a TTI associated with transmitting the control signaling, or a combination thereof
Aspect 5: The method of any of aspects 1 through 4, further including: transmitting a signal to reserve the second resource of the channel.
Aspect 6: The method of any of aspects 1 through 5, where the control signaling includes an indication of an LBT failure, an indication of a quantity of LBT attempts, or a combination thereof
Aspect 7: The method of any of aspects 1 through 6, further including: detecting a RLF with another sidelink device, where transmitting the control signaling is associated with the RLF.
Aspect 8: The method of aspect 7, where the control signaling includes an indication to recover a sidelink communication link using a second channel of the unlicensed radio frequency spectrum band.
Aspect 9: The method of any of aspects 1 through 8, further including: receiving second control signaling from another sidelink device, where transmitting the control signaling is associated with a signal quality measurement of the second control signaling satisfying a threshold.
Aspect 10: The method of any of aspects 1 through 9, where transmitting the control signaling frequency-division multiplexed with the SSB is associated with an LBT exemption.
Aspect 11: The method of any of aspects 1 through 10, where transmitting the control signaling frequency-division multiplexed with the SSB is associated with an LBT failure.
Aspect 12: The method of any of aspects 1 through 11, where transmitting the control signaling includes: interlacing the control signaling using a second frequency resource of the channel that is non-contiguous with a first frequency resource of the channel associated with transmitting the SSB.
Aspect 13: The method of any of aspects 1 through 12, where the control signaling is associated with a broadcast transmission.
Aspect 14: The method of any of aspects 1 through 13, where the control signaling includes an indication of a device identifier for performing a resource selection.
Aspect 15: An apparatus for wireless communication, including one or more interfaces configured to: output a sidelink SSB using a first resource of a channel of an unlicensed radio frequency spectrum band; and output control signaling using a second resource of the channel of the unlicensed radio frequency spectrum band, where the control signaling is frequency-division multiplexed with the SSB.
Aspect 16: The apparatus of aspect 15, where the one or more interfaces are configured to: obtain an indication of an allocation of resources of the unlicensed radio frequency spectrum band, where outputting the control signaling using the second resource is in accordance with the allocation of resources.
Aspect 17: The apparatus of aspect 16, where outputting the control signaling is in accordance with a TTI associated with the allocation of resources.
Aspect 18: The apparatus of any of aspects 15 through 17, where the one or more interfaces are configured to: select the second resource of the channel according to a device identifier, on an index of a TTI associated with outputting the control signaling, or a combination thereof
Aspect 19: The apparatus of any of aspects 15 through 18, where the one or more interfaces are configured to: output a signal to reserve the second resource of the channel.
Aspect 20: The apparatus of any of aspects 15 through 19, where the control signaling includes an indication of an LBT failure, an indication of a quantity of LBT attempts, or a combination thereof
Aspect 21: The apparatus of any of aspects 15 through 20, where the one or more interfaces are configured to: detect a RLF with another sidelink device, where outputting the control signaling is associated with the RLF.
Aspect 22: The apparatus of aspect 21, where the control signaling includes an indication to recover a sidelink communication link using a second channel of the unlicensed radio frequency spectrum band.
Aspect 23: The apparatus of any of aspects 15 through 22, where the one or more interfaces are configured to: obtain second control signaling from another sidelink device, where outputting the control signaling is associated with a signal quality measurement of the second control signaling satisfying a threshold.
Aspect 24: The apparatus of any of aspects 15 through 23, where outputting the control signaling frequency-division multiplexed with the SSB is associated with an LBT exemption.
Aspect 25: The apparatus of any of aspects 15 through 24, where outputting the control signaling frequency-division multiplexed with the SSB is associated with an LBT failure.
Aspect 26: The apparatus of any of aspects 15 through 25, where the one or more interfaces are configured to: interlace the control signaling using a second frequency resource of the channel that is non-contiguous with a first frequency resource of the channel associated with outputting the SSB.
Aspect 27: The apparatus of any of aspects 15 through 26, where the control signaling is associated with a broadcast transmission.
Aspect 28: The apparatus of any of aspects 15 through 27, where the control signaling includes an indication of a device identifier for performing a resource selection.
Aspect 29: The apparatus of any of aspects 15 through 28, included in a UE.
Aspect 30: An apparatus for wireless communication, including: means for transmitting a sidelink SSB using a first resource of a channel of an unlicensed radio frequency spectrum band; and means for transmitting control signaling using a second resource of the channel of the unlicensed radio frequency spectrum band, where the control signaling is frequency-division multiplexed with the SSB.
Aspect 31: The apparatus of aspect 30, further including: means for receiving an indication of an allocation of resources of the unlicensed radio frequency spectrum band, where transmitting the control signaling using the second resource is in accordance with the allocation of resources.
Aspect 32: The apparatus of aspect 31, where transmitting the control signaling is in accordance with a TTI associated with the allocation of resources.
Aspect 33: The apparatus of any of aspects 30 through 32, further including: means for selecting the second resource of the channel according to a device identifier, on an index of a TTI associated with transmitting the control signaling, or a combination thereof
Aspect 34: The apparatus of any of aspects 30 through 33, further including: means for transmitting a signal to reserve the second resource of the channel.
Aspect 35: The apparatus of any of aspects 30 through 34, where the control signaling includes an indication of an LBT failure, an indication of a quantity of LBT attempts, or a combination thereof
Aspect 36: The apparatus of any of aspects 30 through 35, further including: means for detecting a RLF with another sidelink device, where transmitting the control signaling is associated with the RLF.
Aspect 37: The apparatus of aspect 36, where the control signaling includes an indication to recover a sidelink communication link using a second channel of the unlicensed radio frequency spectrum band.
Aspect 38: The apparatus of any of aspects 30 through 37, further including: means for receiving second control signaling from another sidelink device, where transmitting the control signaling is associated with a signal quality measurement of the second control signaling satisfying a threshold.
Aspect 39: The apparatus of any of aspects 30 through 38, where transmitting the control signaling frequency-division multiplexed with the SSB is associated with an LBT exemption.
Aspect 40: The apparatus of any of aspects 30 through 39, where transmitting the control signaling frequency-division multiplexed with the SSB is associated with an LBT failure.
Aspect 41: The apparatus of any of aspects 30 through 40, where the means for transmitting the control signaling include: means for interlacing the control signaling using a second frequency resource of the channel that is non-contiguous with a first frequency resource of the channel associated with transmitting the SSB.
Aspect 42: The apparatus of any of aspects 30 through 41, where the control signaling is associated with a broadcast transmission.
Aspect 43: The apparatus of any of aspects 30 through 42, where the control signaling includes an indication of a device identifier for performing a resource selection.
Aspect 44: A non-transitory computer-readable medium storing code for wireless communication, the code including instructions executable by a processor to: transmit a sidelink synchronization signal block (SSB) using a first resource of a channel of an unlicensed radio frequency spectrum band; and transmit control signaling using a second resource of the channel of the unlicensed radio frequency spectrum band, where the control signaling is frequency-division multiplexed with the SSB.
Aspect 45: The non-transitory computer-readable medium of aspect 44, where the instructions are further executable by the processor to: receive an indication of an allocation of resources of the unlicensed radio frequency spectrum band, where transmitting the control signaling using the second resource is in accordance with the allocation of resources.
Aspect 46: The non-transitory computer-readable medium of aspect 45, where transmitting the control signaling is in accordance with a TTI associated with the allocation of resources.
Aspect 47: The non-transitory computer-readable medium of any of aspects 44 through 46, where the instructions are further executable by the processor to: select the second resource of the channel according to a device identifier, on an index of a TTI associated with transmitting the control signaling, or a combination thereof.
Aspect 48: The non-transitory computer-readable medium of any of aspects 44 through 47, where the instructions are further executable by the processor to: transmit a signal to reserve the second resource of the channel.
Aspect 49: The non-transitory computer-readable medium of any of aspects 44 through 48, where the control signaling includes an indication of an LBT failure, an indication of a quantity of LBT attempts, or a combination thereof
Aspect 50: The non-transitory computer-readable medium of any of aspects 44 through 49, where the instructions are further executable by the processor to: detect a RLF with another sidelink device, where transmitting the control signaling is associated with the RLF.
Aspect 51: The non-transitory computer-readable medium of aspect 50, where the control signaling includes an indication to recover a sidelink communication link using a second channel of the unlicensed radio frequency spectrum band.
Aspect 52: The non-transitory computer-readable medium of any of aspects 44 through 51, where the instructions are further executable by the processor to: receive second control signaling from another sidelink device, where transmitting the control signaling is associated with a signal quality measurement of the second control signaling satisfying a threshold.
Aspect 53: The non-transitory computer-readable medium of any of aspects 44 through 52, where transmitting the control signaling frequency-division multiplexed with the SSB is associated with an LBT exemption.
Aspect 54: The non-transitory computer-readable medium of any of aspects 44 through 53, where transmitting the control signaling frequency-division multiplexed with the SSB is associated with an LBT failure.
Aspect 55: The non-transitory computer-readable medium of any of aspects 44 through 54, where the instructions to transmit the control signaling are executable by the processor to: interlace the control signaling using a second frequency resource of the channel that is non-contiguous with a first frequency resource of the channel associated with transmitting the SSB.
Aspect 56: The non-transitory computer-readable medium of any of aspects 44 through 55, where the control signaling is associated with a broadcast transmission.
Aspect 57: The non-transitory computer-readable medium of any of aspects 44 through 56, where the control signaling includes an indication of a device identifier for performing a resource selection.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data stored in memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented using hardware or software depends upon the particular application and design constraints imposed on the overall system.

The hardware and data processing apparatus used to implement the various illustrative logics, logical blocks, modules and circuits described in connection with the aspects disclosed herein may be implemented or performed using a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented using hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted using one or more instructions or code of a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one location to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc. Disks may reproduce data magnetically and discs may reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

1. An apparatus for wireless communication, comprising:
one or more interfaces configured to:
output a sidelink synchronization signal block (SSB) using a first resource of a channel of an unlicensed radio frequency spectrum band; and
output control signaling using a second resource of the channel of the unlicensed radio frequency spectrum band, wherein the control signaling is frequency-division multiplexed with the SSB.

2. The apparatus of claim 1, wherein the one or more interfaces are configured to:
obtain an indication of an allocation of resources of the unlicensed radio frequency spectrum band, wherein outputting the control signaling using the second resource is in accordance with the allocation of resources.

3. The apparatus of claim 2, wherein outputting the control signaling is in accordance with a transmission time interval (TTI) associated with the allocation of resources.

4. The apparatus of claim 1, further comprising a processing system configured to:
select the second resource of the channel according to a device identifier, on an index of a transmission time interval (TTI) associated with outputting the control signaling, or a combination thereof.

5. The apparatus of claim 1, wherein the one or more interfaces are configured to:
output a signal to reserve the second resource of the channel.

6. The apparatus of claim 1, wherein the control signaling comprises an indication of a listen-before-talk (LBT) failure, an indication of a quantity of LBT attempts, or a combination thereof.

7. The apparatus of claim 1, further comprising a processing system configured to:
detect a radio link failure (RLF) with another sidelink device, wherein outputting the control signaling is associated with the RLF.

8. The apparatus of claim 7, wherein the control signaling comprises an indication to recover a sidelink communication link using a second channel of the unlicensed radio frequency spectrum band.

9. The apparatus of claim 1, wherein the one or more interfaces configured to:
obtain second control signaling from another sidelink device, wherein outputting the control signaling is associated with a signal quality measurement of the second control signaling satisfying a threshold.

10. The apparatus of claim 1, wherein outputting the control signaling frequency-division multiplexed with the SSB is associated with a listen-before-talk (LBT) exemption.

11. The apparatus of claim 1, wherein outputting the control signaling frequency-division multiplexed with the SSB is associated with a listen-before-talk (LBT) failure.

12. The apparatus of claim 1, further comprising a processing system configured to:
interlace the control signaling using a second frequency resource of the channel that is non-contiguous with a first frequency resource of the channel associated with outputting the SSB.

13. The apparatus of claim 1, wherein the control signaling is associated with a broadcast transmission.

14. The apparatus of claim 1, wherein the control signaling comprises an indication of a device identifier for performing a resource selection.

15. The apparatus of claim 1, included in a user equipment (UE).

16. A method for wireless communication, comprising:
transmitting a sidelink synchronization signal block (SSB) using a first resource of a channel of an unlicensed radio frequency spectrum band; and
transmitting control signaling using a second resource of the channel of the unlicensed radio frequency spectrum band, wherein the control signaling is frequency-division multiplexed with the SSB.

17. The method of claim 16, further comprising:
receiving an indication of an allocation of resources of the unlicensed radio frequency spectrum band, wherein transmitting the control signaling using the second resource is in accordance with the allocation of resources.

18. The method of claim 17, wherein transmitting the control signaling is in accordance with a transmission time interval (TTI) associated with the allocation of resources.

19. The method of claim 16, further comprising:
selecting the second resource of the channel according to a device identifier, on an index of a transmission time interval (TTI) associated with transmitting the control signaling, or a combination thereof.

20. The method of claim 16, further comprising:
transmitting a signal to reserve the second resource of the channel.

21. The method of claim 16, wherein the control signaling comprises an indication of a listen-before-talk (LBT) failure, an indication of a quantity of LBT attempts, or a combination thereof.

22. The method of claim 16, further comprising:
detecting a radio link failure (RLF) with another sidelink device, wherein transmitting the control signaling is associated with the RLF.

23. The method of claim 22, wherein the control signaling comprises an indication to recover a sidelink communication link using a second channel of the unlicensed radio frequency spectrum band.

24. The method of claim 16, further comprising:
receiving second control signaling from another sidelink device, wherein transmitting the control signaling is associated with a signal quality measurement of the second control signaling satisfying a threshold.

25. The method of claim 16, wherein transmitting the control signaling frequency-division multiplexed with the SSB is associated with a listen-before-talk (LBT) exemption.

26. The method of claim 16, wherein transmitting the control signaling frequency-division multiplexed with the SSB is associated with a listen-before-talk (LBT) failure.

27. The method of claim 16, wherein transmitting the control signaling comprises:
interlacing the control signaling using a second frequency resource of the channel that is non-contiguous with a first frequency resource of the channel associated with outputting the SSB.

28. The method of claim 16, wherein the control signaling is associated with a broadcast transmission.

29. (canceled)

30. An apparatus for wireless communication, comprising:
means for transmitting a sidelink synchronization signal block (SSB) using a first resource of a channel of an unlicensed radio frequency spectrum band; and
means for transmitting control signaling using a second resource of the channel of the unlicensed radio frequency spectrum band, wherein the control signaling is frequency-division multiplexed with the SSB.

31-43. (canceled)

44. A non-transitory computer-readable medium storing code for wireless communication, the code comprising instructions executable by a processor to:
transmit a sidelink synchronization signal block (SSB) using a first resource of a channel of an unlicensed radio frequency spectrum band; and
transmit control signaling using a second resource of the channel of the unlicensed radio frequency spectrum band, wherein the control signaling is frequency-division multiplexed with the SSB.

45-57. (canceled)
